(19) United States
(12) Patent Application Publication
(10) Pub. No.: US 2010/0224454 A1
(43) Pub. Date: Sep. 9, 2010

(54) Stepless pressure-varying shock absorber

(76) Inventor: Chen-Hsieh Chen, Foster City, CA (US)

Correspondence Address: Chiayuan Chang, 1217 Beach Park Blvd., Foster City, CA, 94404, US

(21) Appl. No.: 12/379,843

(22) Filed: Mar. 3, 2009

(51) Int. Cl. F16F 9/50

(52) U.S. Cl. 188/282.1

(57) ABSTRACT

A shock absorber includes a partitioning board fixed in a chamber of a cylinder to separate the chamber into first and second compartments receiving a damping fluid. The partitioning board includes a first through-hole in communication with the first and second compartments. A buffering disc is mounted in the chamber and forms a bottom end of the second compartment. A rod is slidably received in the chamber and slideably extends through the first through-hole. A damping valve is securely mounted around the rod and is slideably received in the first compartment. The rod has downwardly decreasing cross sections. A gap is formed between an inner periphery of the first through-hole and an outer periphery of the rod. When the rod moves downward, an area of the gap decreases gradually to gradually increase resistance to the damping fluid flowing from the first compartment into the second compartment via the first through-hole.

### BACKGROUND OF THE INVENTION

The present invention relates to a shock absorber and, more particularly, to a stepless pressure-varying shock absorber.

A shock absorber generally includes a member that can be compressed or stretched when subjected to shock or impact so as to absorb the shock or impact. Shock absorbers have various applications in daily lives and can be of simple designs such as springs utilized in beds and chairs or of complicated designs in various vehicles, mechanical equipment, and houses for shock absorbing purposes.

FIG. 6 shows a conventional shock absorber 2 including a cylinder 21 and a rod 22 having a lower end slideably received in the cylinder 21. A damping valve 23 is mounted to the lower end of the rod 22 and separates an interior of the cylinder 21 into a first compartment 24 and a second compartment 25. Damping fluid is received in the first and second compartments 24 and 25. The damping valve 23 includes two holes 26. The rod 22 moves downward when it is subjected to shock or impact. The damping valve 23 moves downward, and the damping fluid in the second compartment 25 flows through the holes 26 into the first compartment 24. The damping fluid in the second compartment 25 resists movement of the damping valve 25 to provide a damping effect. However, if the cross sectional area ratio of the holes 26 to the damping valve 23 is too small, the damping fluid can not smoothly flow from the second compartment 25 through the holes 26 into the first compartment 24, adversely affecting the damping effect. On the other hand, if the cross sectional area ratio of the holes 26 to the damping valve 23 is too large, the damping fluid will flow from the second compartment 25 through the holes 26 into the first compartment 24 with little resistance, failing to provide desired damping effect.

Thus, a need exists for a shock absorber with desired damping effect.

### BRIEF SUMMARY OF THE INVENTION

A shock absorber according to the preferred teachings of the present invention includes a cylinder having a chamber. A partitioning board is fixed in the chamber and separates the chamber into first and second compartments spaced in a longitudinal axis of the cylinder. The first and second compartments receive a damping fluid. The partitioning board includes a first through-hole extending along the longitudinal axis. The first and second compartments are in communication with each other via the first through-hole. A buffering disc is mounted in the chamber and forms a bottom end of the second compartment. A rod is slidably received in the chamber and slideably extends through the first through-hole of the positioning board. A damping valve is securely mounted around the rod to move therewith. The damping valve is slideably received in the first compartment. The partitioning board is intermediate the damping valve and the buffering disc along the longitudinal axis. The rod has downwardly decreasing cross sections. A gap is formed between an inner periphery of the first through-hole of the partitioning board and an outer periphery of the rod. The buffering disc moves along the longitudinal axis when the rod moves in the chamber along the longitudinal axis.

When the rod moves downward, an area of the gap decreases gradually to gradually increase resistance to the damping fluid flowing from the first compartment into the second compartment via the first through-hole.

In the most preferred form, the partitioning board further includes a second through-hole in communication with the first and second compartments. The second through-hole is spaced from the first through-hole in a radial direction perpendicular to the longitudinal axis. The second through-hole includes an upper portion having a socket. A mesh is mounted in the first compartment. A space defined between the mesh and a side of the partitioning board facing the first compartment. A ball is movably received in the space and has a diameter larger than the second through-hole. The mesh limits floating of the ball in the space. The damping fluid is flowable from the second compartment through the second through-hole and the mesh into the first compartment when the ball is received in the space and is disengaged from the socket. The ball blocks the second through-hole when the ball is received in the socket.

The present invention will become clearer in light of the following detailed description of illustrative embodiments of this invention described in connection with the drawings.

### DESCRIPTION OF THE DRAWINGS

FIG. 1 shows an exploded, perspective view of a shock absorber according to the preferred teachings of the present invention.

FIG. 2 shows a perspective view of the shock absorber of FIG. 1.

FIG. 3 shows a cross sectional view of the shock absorber of FIG. 1 with a rod moved upward.

FIG. 3A shows an enlarged view of a circled portion in FIG. 3.

FIG. 3B shows an enlarged view of another circled portion in FIG. 3.

FIG. 4 shows a cross sectional view of the shock absorber of FIG. 1 with the rod moved downward.

FIG. 4A shows an enlarged view of a circled portion in FIG. 4.

FIG. 4B shows an enlarged view of another circled portion in FIG. 4.

FIG. 5 shows a cross sectional view of the shock absorber of FIG. 1 with the rod moved further downward.

FIG. 5A shows an enlarged view of a circled portion in FIG. 5.

FIG. 5B shows an enlarged view of another circled portion in FIG. 5.

FIG. 6 shows a cross sectional view of a conventional shock absorber.

FIG. 6A shows an enlarged view of a circled portion in FIG. 6.

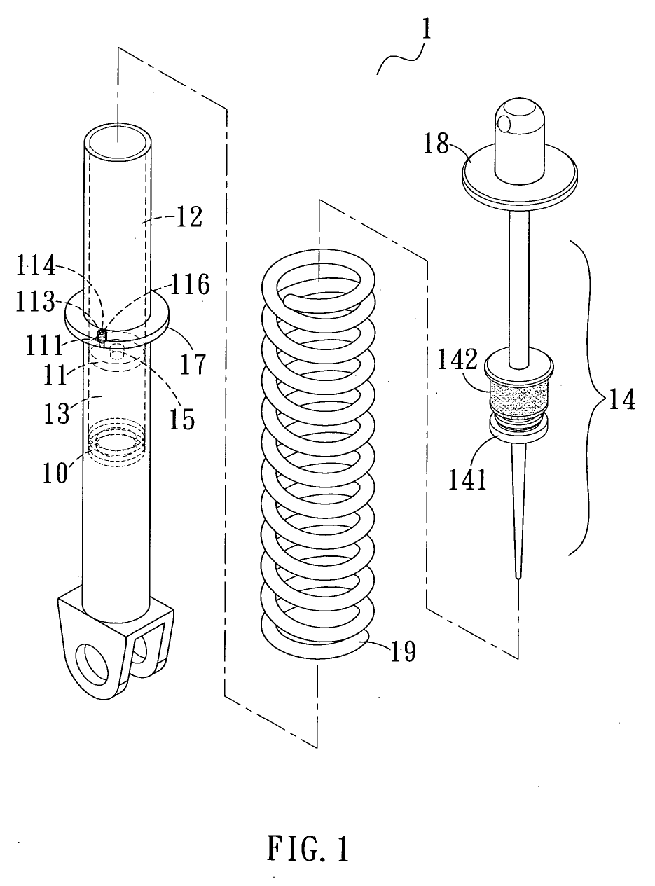

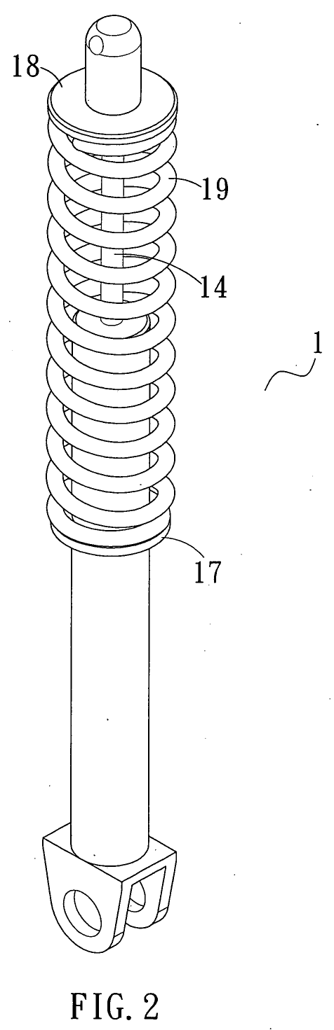

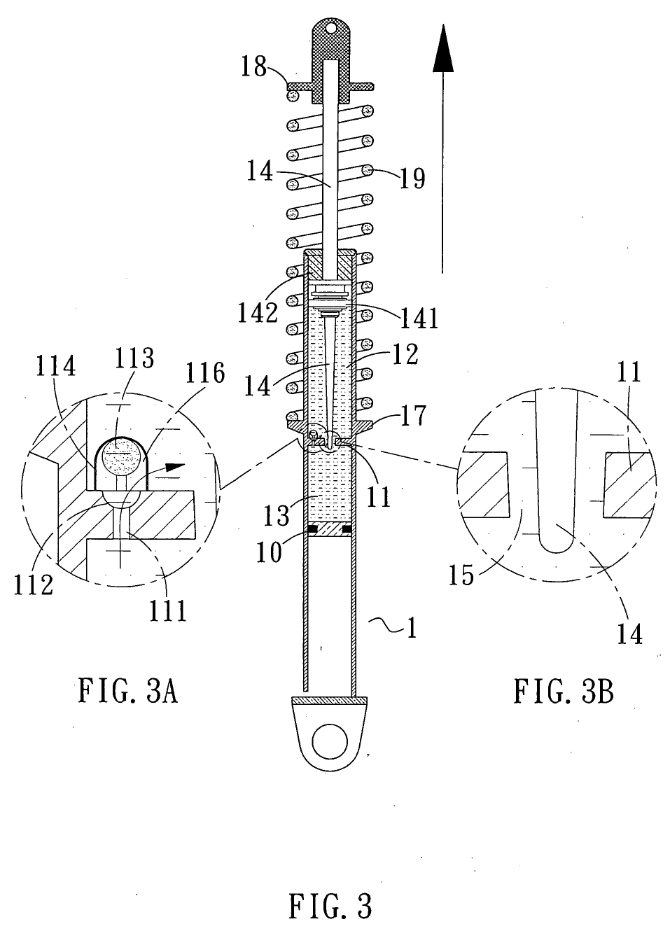

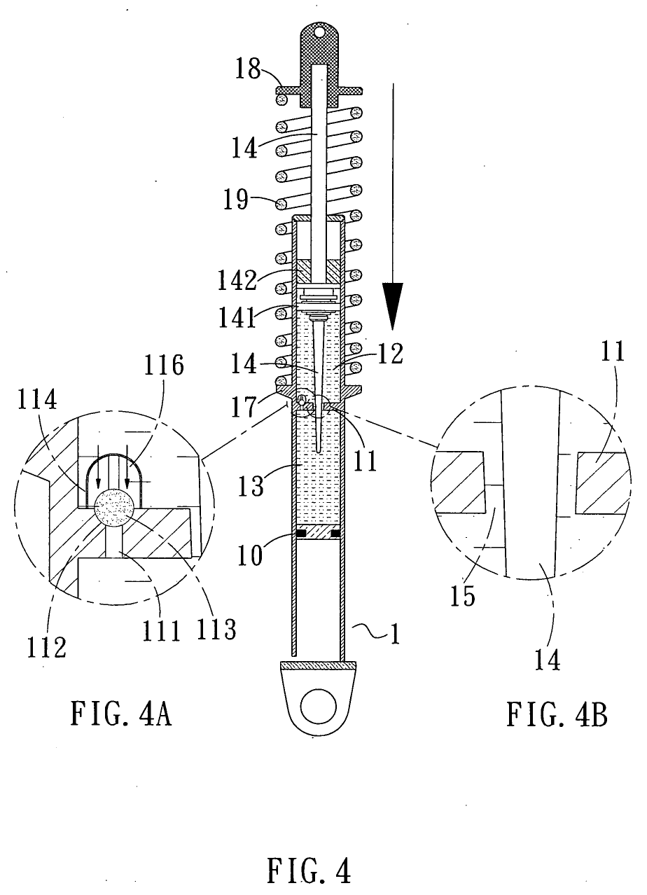

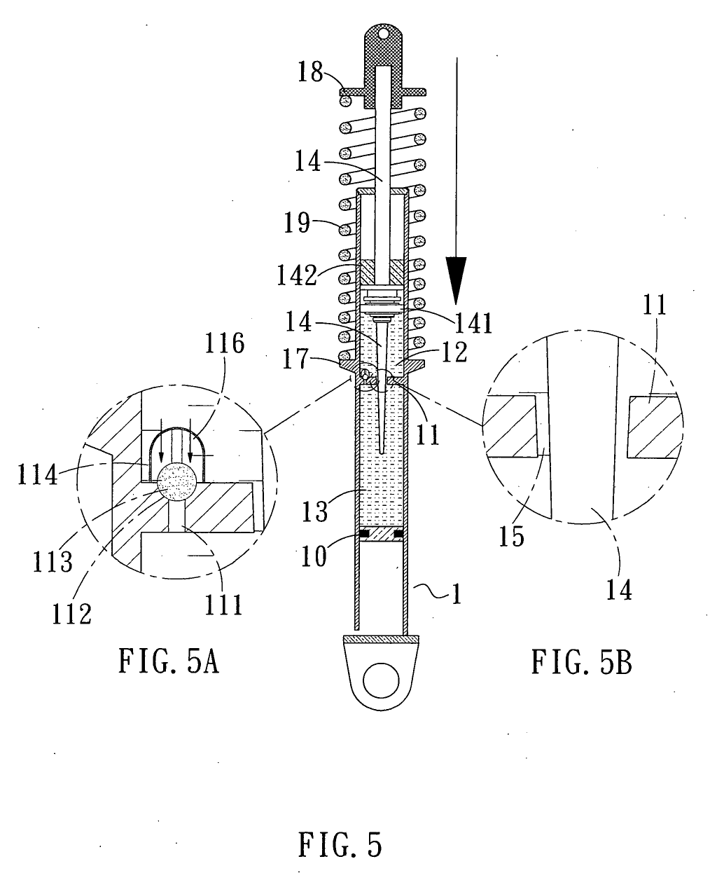

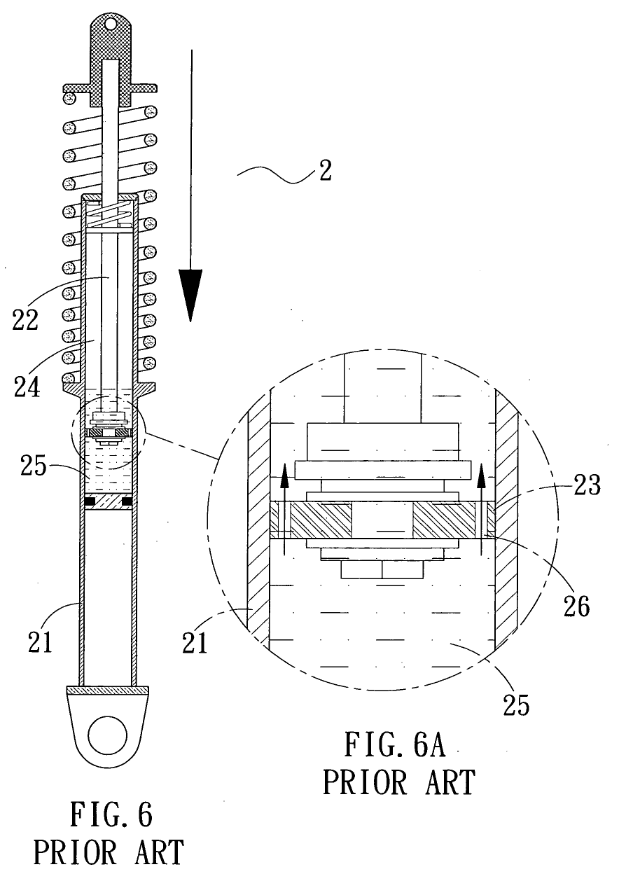

### DETAILED DESCRIPTION OF THE INVENTION

A stepless pressure-varying shock absorber according to the preferred teachings of the present invention is shown in the drawings and can be utilized in various vehicles, mechanical equipment, houses, etc for shock absorbing purposes.

According to the preferred form shown, the stepless pressure-varying shock absorber includes a cylinder 1 having a chamber. A partitioning board 11 is fixed in the chamber and separates the chamber into first and second compartments 12 and 13 spaced along a longitudinal axis of the cylinder 1. The first and second compartments 12 and 13 receive damping fluid such as oil, gas, liquid, etc. The partitioning board 11 includes a first through-hole 15 extending along the longitudinal axis and having an inner periphery. The first and second compartments 12 and 13 are in communication with each other via the first through-hole 15. A buffering disc 10 is mounted in the chamber and below the partitioning plate 11. The buffering disc 10 forms a bottom end of the second compartment 13.

According to the preferred form shown, a rod 14 is slidably received in the chamber and slideably extends through the first through-hole 15 of the positioning board 11. A gap is formed between the inner periphery of the first through-hole 15 of the partitioning board 11 and an outer periphery of the rod 14. An upper end of the rod 14 extends out of the cylinder 1 and is attached to an object including but not limited to a vehicle, a house, mechanical equipment, etc for absorbing shock and vibration imparted to the object.

A damping valve 141 is securely mounted around the rod 14 to move therewith. The damping valve 141 is slideably received in the first compartment 12. The partitioning board 11 is intermediate the damping valve 141 and the buffering disc 10 along the longitudinal axis. The buffering disc 10 moves up and down along the longitudinal axis when the rod 14 moves up and down in the chamber along the longitudinal axis due to impact or vibration imparted to the rod 14 from the object. Specifically, when the rod 14 moves downwardly, the damping fluid flows from the first compartment 12 into the second compartment 13, and the buffering disc 10 moves downward. On the other hand, when the rod 14 moves upwardly, the damping fluid flows from the second compartment 13 into the first compartment 13, and the buffering disc 10 moves upward. Vibration imparted to the rod 14 is absorbed while the damping fluid flows from the first compartment 12 to the second compartment 13 or from the second compartment 13 to the first compartment 12, providing a buffering effect.

According to the preferred form shown, the rod 14 has downwardly decreasing cross sections. In the most preferred form shown, the rod 14 has circular cross sections, and the circular cross sections of the rod 14 gradually decrease toward the buffering disc 10. Thus, when the rod 14 moves downward, an area of the gap gradually changes to gradually increase resistance to the damping fluid flowing from the first compartment 12 into the second compartment 13 via the first through-hole 15. Specifically, the area of the gap allowing the damping fluid to flow from the first compartment 12 into second compartment 13 gradually decreases when the rod 14 moves downward. The damping effect is, thus, increased gradually during the downward movement of the rod 14. Thus, the shock absorber according to the preferred teachings of the present invention can provide differing damping effects and differing shock absorbing effects responsive to differing vibration extents, and the pressure of the flowing damping fluid varies in a stepless manner. It can be appreciated that the rod 14 can have other cross sections other than circular. As an example, the rod 14 can have polygonal cross sections.

In the most preferred form shown, the partitioning board 11 further includes a second through-hole 111 in communication with the first and second compartments 12 and 13. The second through-hole 111 is spaced from the first through-hole 15 in a radial direction perpendicular to the longitudinal axis. The second through-hole 111 includes an upper portion having a socket 112 with a diameter larger than that of a lower portion of the second through-hole 111. A mesh 114 is mounted in the first compartment 12. A space 116 is defined between the mesh 114 and a side of the partitioning board 11 facing the first compartment 12. A ball 113 is movably received in the space 116 and has a diameter larger than the second through-hole 111. The mesh 114 limits floating of the ball 113 in the space 116. When the rod 14 moves upward, the damping fluid is flowable from the second compartment 13 through the second through-hole 111 and pushes the ball 113 upward into in the space 116. Thus, the ball 113 is disengaged from the socket 112 so that the damping fluid is continuously flowable from the second compartment 13 into the first compartment 12 via the first through-hole 15 and via the second through-hole 111 and the mesh 114. When the rod 14 moves downward, the ball 113 is pushed into the socket 112 by the damping fluid flowing from the first compartment 12 through the mesh 114 into the space 116. Thus, the ball 113 blocks the second through-hole 111 when the rod 14 moves downward, and the damping fluid flows from the first compartment 12 to the second compartment 13 via the first through-hole 13.

In the most preferred form shown, an elastomer 142 is mounted between the damping valve 141 and an upper end of the cylinder 1 to reduce impact between the damping valve 141 and the upper end of the cylinder 1 and to provide a sealing effect preventing leakage of the damping fluid. Furthermore, a first attachment member 17 is provided on an outer periphery of the cylinder 1, a second attachment member 18 is provided on the upper end of the rod 14 outside of cylinder 1, and an elastic element 19 is mounted between the first and second attachment members 17 and 18 to provide enhanced damping effect.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A shock absorber comprising:
a cylinder including a chamber, with a partitioning board fixed in the chamber and separating the chamber into first and second compartments spaced in a longitudinal axis of the cylinder, with the first and second compartments receiving a damping fluid, with the partitioning board including a first through-hole extending along the longitudinal axis and having an inner periphery, with the first and second compartments being in communication with each other via the first through-hole, with a buffering disc mounted in the chamber and forming a bottom end of the second compartment; and
a rod slidably received in the chamber and slideably extending through the first through-hole of the positioning board, with a damping valve securely mounted around the rod to move therewith, with the damping valve slideably received in the first compartment, with the partitioning board intermediate the damping valve and the buffering disc along the longitudinal axis, with the rod having downwardly decreasing cross sections, with a gap formed between the inner periphery of the first through-hole of the partitioning board and an outer periphery of the rod, with the buffering disc moving along the longitudinal axis when the rod moves in the chamber along the longitudinal axis,
wherein when the rod moves downward, an area of the gap decreases gradually to gradually increase resistance to the damping fluid flowing from the first compartment into the second compartment via the first through-hole.

2. The shock absorber as claimed in claim 1, with the partitioning board further including a second through-hole in communication with the first and second compartments, with the second through-hole spaced from the first through-hole in a radial direction perpendicular to the longitudinal axis, with the second through-hole including an upper portion having a socket, with a mesh mounted in the first compartment, with a space defined between the mesh and a side of the partitioning board facing the first compartment, with a ball movably received in the space and having a diameter larger than the second through-hole, with the mesh limiting floating of the ball in the space, with the damping fluid flowable from the second compartment through the second through-hole and the mesh into the first compartment when the ball is received in the space and is disengaged from the socket, and with the ball blocking the second through-hole when the ball is received in the socket.

3. The shock absorber as claimed in claim 2, with the damping fluid flowing from the second compartment to the first compartment via the first through-hole and via the second through-hole and the mesh with the ball not blocking the second through-hole when the rod moves upward, and with the damping fluid flowing from the first compartment to the second compartment via the first through-hole with the ball blocking the second through-hole when the rod moves downward.

4. The shock absorber as claimed in claim 2, with the rod having circular cross sections, and with the circular cross sections of the rod gradually decreasing toward the buffering disc.

5. The shock absorber as claimed in claim 2, further comprising an elastomer mounted between the damping valve and an upper end of the cylinder.

6. The shock absorber as claimed in claim 1, with the rod including an upper end extending upward out of the cylinder, with the shock absorber further comprising: a first attachment member provided on an outer periphery of the cylinder; a second attachment member provided on the upper end of the rod; and an elastic element mounted between the first and second attachment members.
